(19) United States
(12) Patent Application Publication
(10) Pub. No.: US 2013/0339424 A1
(43) Pub. Date: Dec. 19, 2013

(54) DERIVING A SERVICE LEVEL AGREEMENT FOR AN APPLICATION HOSTED ON A CLOUD PLATFORM

(71) Applicants: Anjaneyulu Pasala, Bangalore (IN); Sumit Kumar Bose, Poorvi (IN); Ganesan Malaiyandisamy, Bangalore (IN); Sridhar Murthy Jayaram, Bangalore (IN)

(72) Inventors: Anjaneyulu Pasala, Bangalore (IN); Sumit Kumar Bose, Poorvi (IN); Ganesan Malaiyandisamy, Bangalore (IN); Sridhar Murthy Jayaram, Bangalore (IN)

(73) Assignee: Infosys Limited, Bangalore (IN)

(21) Appl. No.: 13/524,209

(22) Filed: Jun. 15, 2012

(51) Int. Cl. G06F 15/16

(52) U.S. Cl. 709/203; 709/201

(57) ABSTRACT

Systems and methods for deriving a service level agreement for an application hosted on a cloud platform are defined. In accordance with at least one embodiment, deriving the service level agreement comprises packaging the application for deployment on a cloud platform, executing the packaged application in a sandboxed environment and capturing one or more application performance characteristics thereby, executing the packaged application in a sandboxed virtualized platform and further capturing one or more application performance characteristics thereby, mapping the one or more captured application performance characteristics to one or more service level objectives, and deriving a service level agreement on the basis of the one or more service level objectives, wherein the service level agreement comprises at least one of the one or more service level objectives.

### FIELD

The invention relates generally to the derivation of a service level agreement for utilizing services offered by a cloud platform provider. In particular, the invention relates to the derivation of a service level agreement for an application that is to be hosted on a cloud platform by analyzing one or more of the application's performance characteristics.

### BACKGROUND

Typically, in the service hosting arena, service providers and customers enter into an agreement for that governs the usage of services offered by the cloud platform provider. These agreements are called Service Level Agreements (SLAs). SLAs, in turn, consist of several service level objectives (SLO). SLOB are usually defined based on certain key criteria linked to the service provider, such as, for example, criteria relating to usage of storage or compute resources. With the increasing complexity of cloud platform architectures and their associated management processes, this list of key criteria has grown, and the associated difficulty of identifying and quantifying them has grown in turn.

Along with the growth in computing hardware capability, the number and complexity of web applications has risen, while, at the same time, application hosting has become an increasingly important service offered by cloud platform providers as enterprises realized that it was economical to outsource application hosting activity. Procuring expensive hardware upfront, without knowing the viability of the hosting business, is a significant risk that enterprises were, and are, not willing to take. In essence, by being allowed the flexibility to categorize hardware and application maintenance as non-core activities of their business, enterprises are able to concentrate resources on improving other aspects of their applications, such as user experience and functionality. Accordingly, the level of sophistication required to manage these data centers, or cloud platforms, where numerous applications could be hosted simultaneously increased manifold, along with the cost of maintaining them.

Additionally, it is desirable that service level agreements (SLA) are specific to an application being hosted. In large scale cloud platforms, it is rarely the case that a single SLA is defined for a disparate set of applications that share the same resources. To this end, an overall integrated, framework for deriving a governing SLA and its automated management is desirable. Such an SLA would take into account individual application characteristics while maximizing overall usage of cloud resources under a common set of governing policies.

Additionally, cloud service providers may allocate all infrastructural resources requested by an enterprise customer for the deployment of applications, and then charge the enterprise customer for the allocated infrastructural resources, irrespective of whether the allocated infrastructural resources have been fully utilized. In such an instance, small and medium enterprises that need infrastructural resources for hosting their applications may find that they are resource starved due to non-availability, even though these resources are not completely utilized by large enterprises.

Accordingly, there is a need for a method or system for deriving an integrated service level agreement for an application hosted on a cloud platform that is able to optimize the utilization of cloud infrastructural resources with respect to demand.

### SUMMARY

The present invention describes a computer program product comprising a computer readable medium having a computer readable program code embodied therein for deriving a service level agreement for an application to be hosted in a cloud platform, and comprising the program steps of packaging the application for deployment on a cloud platform, wherein packaging the application includes creating deployable components on the cloud platform; executing the packaged application in a sandboxed environment, wherein the sandboxed environment comprises at least one physical server, and capturing one or more application performance characteristics thereby; executing the packaged application in a sandboxed virtualized platform and further capturing one or more application performance characteristics thereby; mapping the one or more captured application performance characteristics to one or more service level objectives, wherein a service level objective is selected from a group of application parameters related to the cloud platform consisting of infrastructure availability, security and performance parameters; and deriving a service level agreement on the basis of the one or more service level objectives, wherein the service level agreement comprises at least one of the one or more service level objectives.

In an additional aspect, a system for deriving a service level agreement for an application is disclosed, the system comprising at least one processor and a processor readable memory in operable communication with the at least one processor, with at least one interface operable to provide a communication link to at least one network device, and thereby operable to package the application for deployment on a cloud platform, wherein packaging the application includes the creation of deployable components on the cloud platform; execute the packaged application in a first sandboxed environment comprising at least one physical server in the cloud platform and a second sandboxed environment comprising at least one virtualized computing environment in the cloud platform, and capture one or more application performance characteristics exhibited in each of the sandboxed environments; map the one or more captured application performance characteristics to one or more service level objectives, wherein a service level objective is selected from a group consisting of business and infrastructural parameters related to the cloud platform; and derive a service level agreement on the basis of the one or more service level objectives, wherein the service level agreement comprises at least one of the one or more service level objectives.

### DRAWINGS

These and other features, aspects, and advantages of the present invention will be better understood when the following detailed description is read with reference to the accompanying drawings in which like characters represent like parts throughout the drawings, wherein:

FIG.1 is an illustrative flow diagram depicting a method of deriving a service level agreement for an application hosted on a cloud platform.

FIG. 2 is a diagram depicting the dedicated hosting of enterprise applications on a cloud platform.

FIG. 3 is a diagram depicting the shared hosting of applications on a cloud platform comprising physical and virtualized servers.

FIG. 4 is an illustrative architecture diagram of a computing environment in which a service level agreement is derived.

FIG. 5a is a comparative depiction of resource usage by an application in a resource optimized, virtualized cloud platform to that in a non-resource optimized cloud platform.

FIG. 5b is a depiction of an optimized application resource usage pattern for two concurrently running applications in a resource optimized, virtualized cloud platform.

### DETAILED DESCRIPTION

The following description is the full and informative description of the best method and system presently contemplated for carrying out the present invention which is known to the inventors at the time of filing the patent application. Many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. As such, the present description should be considered as merely illustrative of the principles of the present technique and not in limitation thereof, since the present technique is defined solely by the claims.

Disclosed embodiments relate to a system and method for deriving a service level agreement for an application hosted on a cloud platform.

When enterprise developed web applications are to be deployed on the infrastructure of third-party application service providers (ASPs), a general practice of such providers was to obtain the required hardware and make that available for application hosting. In order to ensure a reliable and consistent hosting performance, enterprises could then enter into an agreement with the ASPs to guarantee a minimum quality of service (QoS). This agreement is known as the service-level agreement (SLA).

Service level agreements (SLA), generally, outline terms for the conduct of business between a service provider and a consumer. Terms that bind the service provider, as well as the conditions under which services are provided, are generally contained within an SLA, and these are characterized as Service Level Objectives (SLOs). Typically, SLOs are defined based on the key criteria of the services such as usage of network, compute and storage resources, and security. For example, one SLA may state that the application's server machine will be available for 99.9% of the key business hours of the application's end users, also called core time, and 85% of the non-core time. Another SLA may state that the service provider would respond to a reported issue in less than 10 minutes during the core time, but would respond in one hour during non-core time.

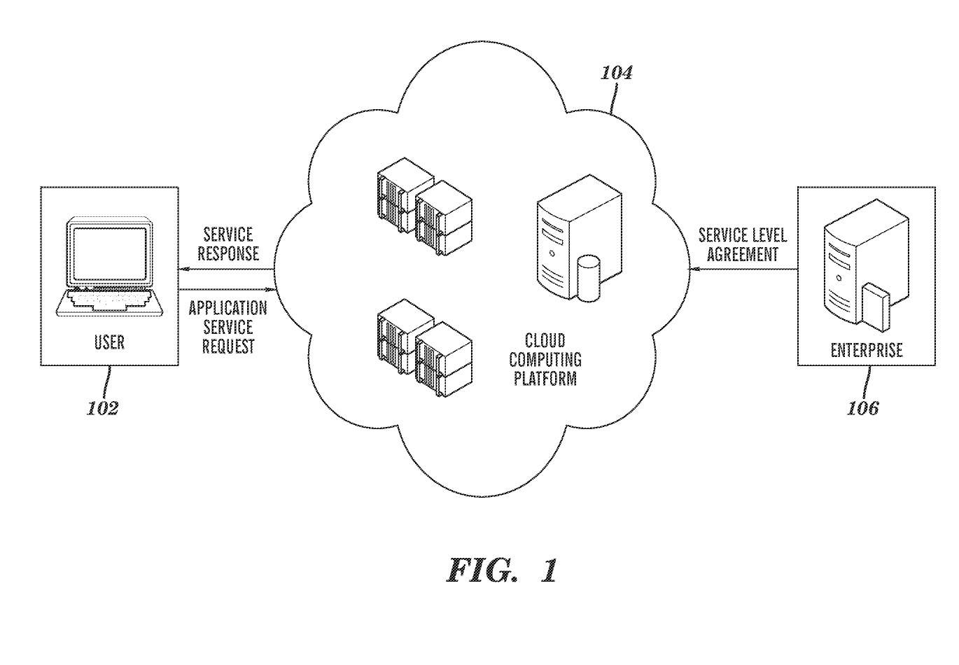

In FIG. 1, a scenario is depicted wherein enterprise applications are hosted on a typical service infrastructure provider's dedicated servers, 104, and the conditions for such hosting are governed by a service level agreement, as in 106. Users would then be able to access the application by connecting to the service provider directly, or through an intermediary application, such as an internet browser, as in 102.

However, availability of infrastructure does not guarantee uniform availability of the application for its end users. Often, an information technology (IT) team associated with the enterprise would perform capacity planning in advance of deployment to an ASP, and the ASP would procure resources accordingly. This dedicated hosting practice resulted in massive redundancies within the ASP's data centers due to the underutilization of many of their servers as hosted applications were not always fully utilizing their servers' capacity at nonpeak loads. To reduce redundancy and increase server utilization in data centers, co-hosting applications, i.e. deployment of more than one application on a single server, with complementary workload patterns is desirable.

There are multiple challenges involved for the ASP in co-hosting disparate applications and managing disparate SLAs, however. For example, co-hosting presents new challenges relating to application performance and security. An important aspect of application performance is related to the degree of performance isolation afforded to an application. Performance isolation is the condition wherein one application is ring-fenced, and thereby unable to use infrastructural resources being utilized by other co-located applications. For example, assume that application A is required to use more quantity of a resource than originally allocated to it for duration of time t. For that duration the amount of the same resource available to application B is decreased. This could adversely affect the performance of application B.

In another example, the application may be a black box to the ASP and the ASP, thereby, has virtually no knowledge about the application runtime characteristics. Therefore, the ASP needs to determine the right amount of computing resources required for different components of an application at various workloads, the application's performance bottlenecks and its scalability before guaranteeing a service level.

In another example, the ASP may analyze the application before live deployment. However, a subsequent enhancement or auto-update by the customer to the application can impact the performance of the application, thereby putting the ASP's fulfillment of the application's SLA at risk.

In another example, if all customers decide to select a highest grade of SLA simultaneously, there may not be a sufficient number of servers available to the ASP for provisioning and meeting the SLA obligations, particularly when the risk of capacity planning is with the service provider instead of the customer.

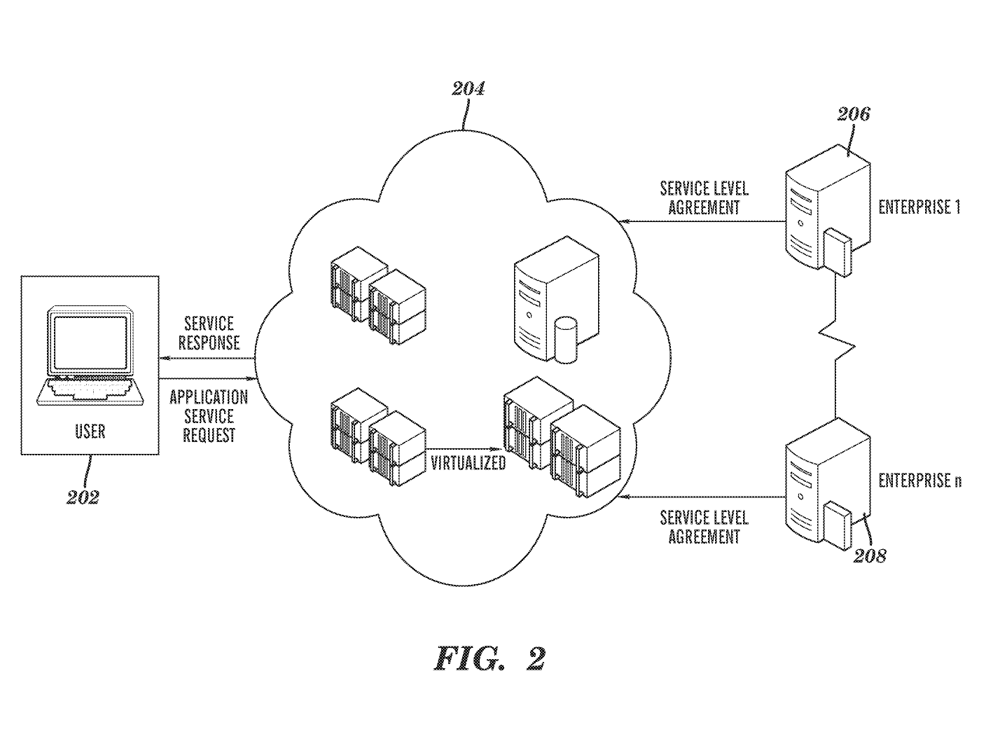

An aspect of the resolution of these concerns involves virtualization. Here, the applications, instead of being hosted on the physical machines, are encapsulated using virtual machines. These virtual machines are then mapped to the physical machines. In FIG. 2, for example, an ASP providing large scale application hosting on a cloud platform, 204, is depicted. The cloud platform 204 comprises one or more physical servers and one or more virtual machines, or platforms that run on the one or more physical servers. In this instance, the cloud platform is able to support a plurality of applications from each of a plurality of enterprises, as in 206 and 208. Each of the enterprises may have an agreed upon SLA with the ASP which determines the conditions under which the applications are hosted. The SLA, in turn, affects the user experience in terms of, for example, service response time when an application service request is received from a user, as in 202.

Therefore, as ASPs acquire the responsibility to meet a customer's application SLOs, it is vital that they be flexible in allocating and de-allocating computing resources among the co-located applications that they host, while, at the same time, ensuring continuity in application performance relative to the service level agreement. Deriving the service level agreement for an application by the ASP, then, is a key aspect of managing the application to be deployed on the ASP's cloud platform.

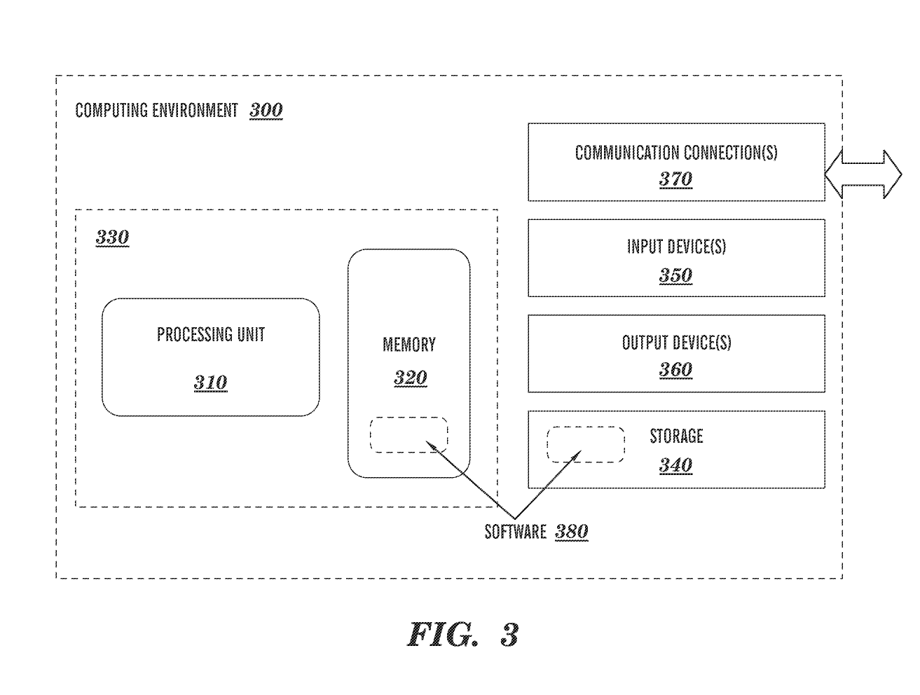

In accordance with an embodiment, the problems presented may be addressed by the derivation of a service level agreement that is specific to both an application and the ASP's cloud platform on which the application is to be deployed. Referring now to FIG. 3, a computing environment 300 in which a service level agreement may be derived is depicted, the computing environment comprising a processing unit 310, a communication connection 370, an input device 350, an output device 360, and a processor readable storage medium 340, in operable communication with the processing unit 310, is depicted. The computing environment runs a software 380, the software 380 stored on the computer readable storage medium, and consisting of one or more programming instructions stored in the processor readable storage medium, the programming instructions suitable for deriving a service level agreement for a cloud platform.

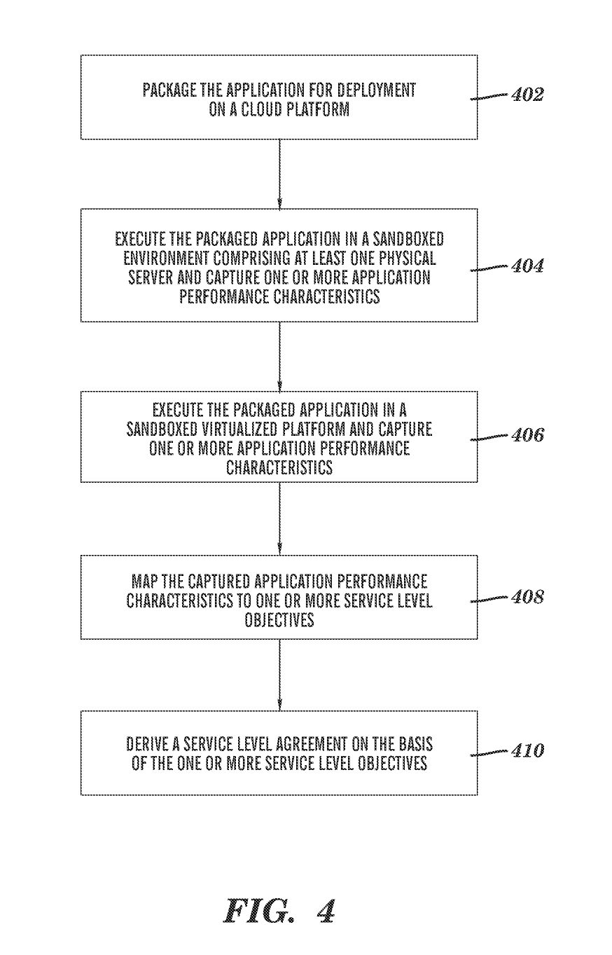

In accordance with an embodiment that may be implemented in the computing environment 300, a first step in the derivation of a service level agreement for an application to be deployed in a cloud platform involves the packaging of the application for deployment in the cloud platform, in accordance with a step 402 of FIG. 4. The packing of the application involves the creation of deployable components on the cloud platform, where the deployable components created are either physical or virtual. In some embodiments, for example, the Open Virtualization Format (OVF) standard is used for packaging the application for a cloud platform.

Then, as in a step 404, the packaged application is executed directly on one or more physical servers present in the ASP's cloud platform and the application's performance characteristics captured thereby. The one or more physical servers may be configured to present a sandboxed environment, whereby the application's performance characteristics are captured without the influence of external factors. Such a step allows for the functional validation of the customer's application. Furthermore, such a step also provides a baseline performance value for the application in a non-virtual environment. Additionally, it helps in identifying the nature of the application—that is, whether it is CPU-intensive, I/O intensive or network-intensive, and potential performance bottlenecks therein.

Then, as in a step 406, the application is executed on a sandboxed virtualized platform and the application performance characteristics are captured again. In some embodiments, important performance characteristics like the application's ability to scale, i.e. to scale out or to scale up, and performance bounds, i.e. minimum and maximum performance, are noted.

Then, as in a step 408, the captured application performance characteristics are mapped to one or more service level objectives. Based on the measured performance characteristics, different possible SLOs may be identified, and a corresponding service level agreement derived thereby, as in the step 410. In some embodiments, the resources required and the costs involved for each SLA are also computed. In an additional embodiment, two or more service level agreements are derived in the manner disclosed.

In some embodiments, a feasibility study may be conducted by the ASP prior to deployment. Feasibility studies generally involve three kinds of feasibility: (1) technical feasibility, (2) infrastructure feasibility, and (3) financial feasibility.

The technical feasibility of an application implies determining the following: Firstly, the ability of an application to scale out. Second, the compatibility of the application with the cloud platform being used within the ASP's data center. Third, the need and availability of a specific hardware and software required for hosting and running the application. Fourth, preliminary information about application performance and whether they can be met by the infrastructure deployed by the ASP.

As in an example embodiment, performing the infrastructure feasibility study involves determining the availability of infrastructural resources in sufficient quantity so that the projected demands of the application can be met. Similarly, the financial feasibility study involves determining the approximate cost to be incurred by the ASP and the price the ASP charges the customer.

The appropriate cost incurred by the ASP is determined by the SLA class the application belongs to. The SLA classes are classified, for example, into tiers such as Platinum, Gold, Silver, Bronze etc. As the name suggests, cost varies across each of these and, in addition, each class of SLA may attract a proportionate penalty for breach. In general, breaches can be categorized into ‘already breached’ and ‘verge of breaching’ states, and may be further classified on the basis of a number of applications belonging to the same customer that breach the SLA.

In accordance with a disclosed embodiment, a feasibility report consists of the results of the above three feasibility studies. The report forms the basis for further communication with the customer. Once the provider and customer agree upon the findings of the report, the outsourcing of the application hosting activity proceeds to the next phase.

In some embodiments, policies for automated management of the application may be created. Policies created may include at least one of: (1) business, (2) operational, and (3) provisioning policies. In general, the amount of system resources allocated or de-allocated to or from appropriate components of the application when the load on the system increases/decreases are determined by the policies created.

Specifically, and in accordance with a disclosed embodiment, business policies help prioritize access to infrastructural resources of the cloud in case of contentions between one or more of the co-hosted applications. Business policies may be in the form of weights for different customers or groups of customers.

Operational policies may define actions to be taken when different thresholds or conditions are reached. Additionally, actions taken when a threshold, a condition or a trigger defined by the ASP when the one or more service-level parameters are breached or about to be breached may be defined in the operational policy. Corrective action may include different types of provisioning such as scale-up, scale-down, scale-out, scale-in, and so on, of a particular tier of an application. Additionally, administrator notification or logging, by creating a log file or writing to a pre-defined log file, may be defined in the operational policy.

Operational policies (OP) may be represented in the following format:

OP=collection of (Condition, Action)

In accordance with an embodiment, the action taken may be further represented by a workflow defining a sequence of actions to be undertaken. For example, if an operational policy is defined as:

OP=(average latency of web server>0.8 sec, scale-out the web-server tier)

Then, if the average latency of a web server in the cloud platform is more than 0.8 sec then the numbers of instances of the web server are increased.

Provisioning policies define a sequence of actions corresponding to external inputs or user requests. For example, scaling-out, scaling-in, starting, stopping, suspending and resuming the application may comprise actions defined in a provisioning policy. A provisioning policy (PP) may be represented as:

PP=collection of (Request, Action)

For example, a provisioning policy to start a web site consists of the following sequence: start database server, start web-server instance 1, followed by start the web-server instance 2, and so on. In accordance with an embodiment, on defining these policies, the packaged applications are deployed on the cloud platform and the application is tested to validate whether the policies are able to meet SLA requirements. This step is iterative and is repeated until all the infrastructure conditions necessary to satisfy the application SLA are identified.

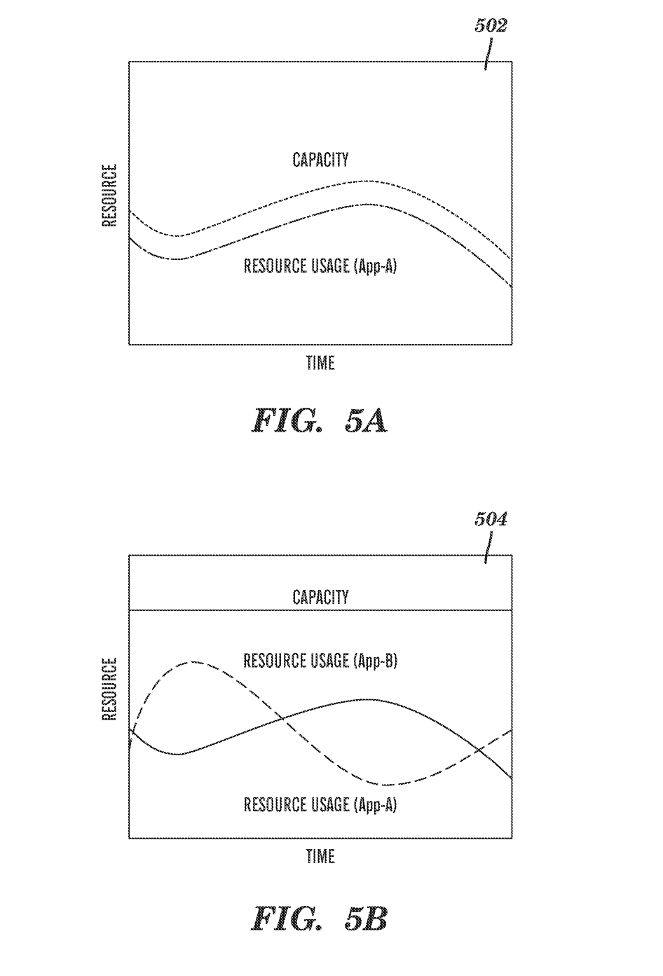

Benefits associated with the disclosed implementation are depicted in FIG. 5a, and additionally in FIG. 5b. Efficient management of cloud infrastructural resources can provide a significant improvement in resource usage relative to available capacity for a single application, as illustrated by 502, as well as additionally enable balanced, sustainable resource usage across multiple applications, as depicted by 504.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages.

This description is presented to enable a person of ordinary skill in the art to make and use the invention and is provided in the context of the requirement for a obtaining a patent. The present description includes the best presently-contemplated implementation of the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer program product comprising a computer readable medium having a computer readable program code embodied therein for deriving a service level agreement for an application to be hosted in a cloud platform, and comprising the program steps of:
packaging the application for deployment on a cloud platform, wherein packaging the application includes creating deployable components on the cloud platform;
executing the packaged application in a sandboxed environment, wherein the sandboxed environment comprises at least one physical server, and capturing one or more application performance characteristics thereby;
executing the packaged application in a sandboxed virtualized platform and further capturing one or more application performance characteristics thereby;
mapping the one or more captured application performance characteristics to one or more service level objectives, wherein a service level objective is selected from a group of application parameters related to the cloud platform consisting of infrastructure availability, security and performance parameters; and
deriving a service level agreement on the basis of the one or more service level objectives, wherein the service level agreement comprises at least one of the one or more service level objectives.

2. The method as claimed in claim 1, further comprising performing an infrastructure feasibility study, a financial feasibility study and a technical feasibility study prior to packaging the application for deployment.

3. The method as claimed in claim 2, wherein the technical feasibility study comprises determining the ability of the application to be hosted to scale out and the compatibility of the application with the cloud platform on which the application is to be hosted.

4. The method as claimed in claim 2, wherein the infrastructure feasibility study comprises determining the availability of infrastructural resources in the cloud platform to support the deployment of the application.

5. The method as claimed in claim 2, wherein the infrastructure feasibility study comprises determining a pattern of usage of infrastructural resources by the application to be deployed in the cloud platform in order to ensure that the application to be deployed is able to coexist with at least one deployed application in the cloud platform.

6. The method as claimed in claim 2, wherein the financial feasibility study comprises determining an approximate cost involved in the deployment of the application on the cloud platform.

7. The method as claimed in claim 2, wherein the financial feasibility study comprises associating the application to be deployed with a service level selected from a set of tiered customer service levels.

8. The method as claimed in claim 1, further comprising creating at least one policy governing the management of the application in response to the service level agreement, wherein the at least one policy defines access to, and usage of, infrastructural resources by the application on the cloud platform.

9. The method as claimed in claim 8, further comprising validating a policy created against one or more requirements associated with the service level agreement by testing the deployed application.

10. The method as claimed in claim 8, wherein the at least one policy created includes a business policy, an operational policy and a provisioning policy.

11. The method as claimed in claim 8, wherein access to infrastructural resources of the cloud platform and resource allocation in case of a resource contention by processes associated with the deployed application is determined by the business policy.

12. The method as claimed in claim 8, wherein the operational policy determines an action to be taken when a predefined condition is reached.

13. The method as claimed in claim 8, wherein the provisioning policy defines a sequence of actions that are triggered by an external input and a user request.

14. The method as claimed in claim 1, wherein the testing process is iteratively repeated until all infrastructure conditions associated with the cloud platform that are necessary to satisfy the identified service level agreement are identified.

15. The method as claimed in claim 1, wherein two or more service level agreements are derived from the one or more service level objectives and each of the two or more service level agreements comprise at least one service level objective.

16. A system for deriving a service level agreement for an application, the system comprising:
at least one processor and a processor readable memory in operable communication with the at least one processor, with at least one interface operable to provide a communication link to at least one network device, the at least one processor thereby configured to:
package the application for deployment on a cloud platform, wherein packaging the application includes the creation of deployable components on the cloud platform;
execute the packaged application in a first sandboxed environment comprising at least one physical server and a second sandboxed environment comprising at least one virtualized computing environment, and capture one or more application performance characteristics exhibited in each of the sandboxed environments;
map the one or more captured application performance characteristics to one or more service level objectives, wherein a service level objective is selected from a group consisting of business and infrastructural parameters related to the cloud platform; and
derive a service level agreement on the basis of the one or more service level objectives, wherein the service level agreement comprises at least one of the one or more service level objectives.

17. The system as claimed in claim 16, further comprising performing an infrastructure feasibility study, a financial feasibility study and a technical feasibility study prior to packaging the application for deployment.

18. The system as claimed in claim 17, wherein the technical feasibility study comprises determining the ability of the application to be hosted to scale out and the compatibility of the application with the cloud platform on which the application is to be hosted.

19. The system as claimed in claim 17, wherein the infrastructure feasibility study comprises determining the availability of infrastructural resources in the cloud platform to support the deployment of the application.

20. The system as claimed in claim 17, wherein the infrastructure feasibility study comprises determining a pattern of usage of infrastructural resources in the cloud platform in order to ensure that the application to be deployed is able to coexist with at least one deployed application in the cloud platform.

21. The system as claimed in claim 17, wherein the financial feasibility study comprises determining an approximate cost involved in the deployment of the application on the cloud platform.

22. The system as claimed in claim 17, wherein the financial feasibility study comprises associating the application to be deployed with a service level selected from a set of tiered customer service levels.

23. The system as claimed in claim 16, further comprising creating at least one policy governing the management of the application in response to the service level agreement, wherein the at least one policy defines access to, and usage of, computing resources by the application on the cloud platform.

24. The system as claimed in claim 23, further comprising validating a policy created against one or more requirements associated with the service level agreement by testing the deployed application.

25. The system as claimed in claim 23, wherein the at least one policy created includes a business policy, an operational policy and a provisioning policy.

26. The system as claimed in claim 23, wherein access to infrastructural resources of the cloud platform and resource allocation in case of a resource contention by processes associated with the deployed application is determined by the business policy.

27. The system as claimed in claim 23, wherein the operational policy determines an action to be taken when a predefined condition is reached.

28. The system as claimed in claim 23, wherein the provisioning policy defines a sequence of actions that are triggered by an external input and a user request.

29. The system as claimed in claim 16, wherein the testing process is iteratively repeated until all infrastructure conditions associated with the cloud platform that are necessary to satisfy the identified service level agreement are identified.

30. The system as claimed in claim 16, wherein two or more service level agreements are derived from the one or more service level objectives and each of the two or more service level agreements comprise at least one service level objective.
